(19) United States
(12) Patent Application Publication
(10) Pub. No.: US 2017/0290729 A1
(43) Pub. Date: Oct. 12, 2017

(54) MOBILITY DEVICE

(71) Applicant: Angad Saluja, New Delhi (IN)

(72) Inventor: Angad Saluja, New Delhi (IN)

(21) Appl. No.: 15/507,732

(22) PCT Filed: Aug. 28, 2015
(86) PCT No.: PCT/IB2015/056531

§ 371 Date: Feb. 28, 2017

(30) Foreign Application Priority Data
Aug. 29, 2014 (IN) 2469/DEL/2014
Oct. 1, 2014 (IN) 2818/DEL/2014

(51) Int. Cl. A61H 3/02; A45B 9/00

(52) U.S. Cl. CPC A61H 3/0277; A45B 9/00; A61H 3/0288

(57) ABSTRACT

The invention relates to a mobility device (100) comprising a top segment (101) and a bottom segment (102) including a first end (103) and a second end (104), the first end (103) being joined to the top segment (101). The bottom segment (102) includes a curved portion (105) positioned between the first and the second ends, wherein the curved portion (105) is adapted to define an energy storing state and an energy releasing state.

### TECHNICAL FIELD

The invention generally relates to walking/mobility aids. More particularly, the invention relates to a mobility device capable of propelling a user/robot forward.

### BACKGROUND

Generally, people with ailments may use some sort of support or walking aids to assist them in walking. The ailments, for example infirmity, backache, bad knees, and so on, may affect the ability of an individual to walk unaided and therefore require support. Alternately, people may require support while walking during the course of activities such as trekking, exercising, and other sports for balancing themselves. However, while using such walking aids, the user may hunch and/or experience pressure on the wrist and other parts of body when the walking aid makes contact with the ground. To minimize such pressure, a walking aid with an energy storage spring is provided. The spring compresses under the weight of the user and therefore acts as shock absorber. However, such walking aid does not provide a forward propelling force which can help propel the user forward while walking.

Various solutions are available that provide dual functions of shock absorption and forward propulsion. By way of example, US 20040107981 describes a flexible shaft, which absorbs shock and releases power as it alternately flexes and returns to original shape. The flexible shaft is slightly curved to ensure flex in the proper direction. Maximum flex is about 8 inches and maximum height is approximately 48″ (4′) for a 5′10″ long user. Also, the flexible shaft includes plastic grip and a rubber tip. However, the flexible shaft can flex to 8″ and therefore does not provide much propelling force while returning to original shape so that the user can propel forward easily.

By way of another example, US 20040250845 describes walking stick having a rigid shaft and a curvilinear shaped flexure spring attached to lower end of the shaft. The flexure spring stores energy from compression during the user's step, and releases the energy to aid in propelling the user forward, thereby reducing fatigue and enabling longer and faster walks. The rigid shaft also includes a handgrip or an arm support made of rigid material. By way of another example, US 20120024634 describes propulsion device having an elongated rod made of elastic material. A first end of the elongated rod is grasped by a human hand and a second end of the elongated rod is on a firm surface for propelling a wheeled vehicle such as a skateboard. A person bends the elongate rod to store energy and then releases the stored energy to use the propulsion device to propel the wheeled vehicle.

Similarly, in the context of multi-legged robots having 3 or more legs such as drones, legs of such robots may be designed such that they help in balancing the weight of the robot body and provides for propulsion that aids robot to move forward. The amount of propulsion required may vary depending on the configuration of the robot body. However, at present, the legs of such robots are made of rigid materials to provide sufficient support and may have multiple mechanical components such as springs, moving parts and motors to provide desired mobility. These components are prone to wear and tear and require high maintenance. Further, the propulsion provided is a function of regenerative braking, in other words energy recovery system. Furthermore, these components do not provide appropriate shock absorption, and ergonomics.

There exists a need for a more efficient mobility aid that allows proper propulsion, shock absorption, and ergonomics in comparison to the existing arts and that is compatible to be used by both humans and robots. Further, the mobility aid should be such that it causes minimum strain on various body parts of human and requires minimum mechanical force for providing mobility in robots.

### SUMMARY OF THE INVENTION

In accordance with the purposes of the invention, the present invention as embodied and broadly described herein, provides for mobility device capable of providing more efficient ergonomic propulsion.

Accordingly, a mobility device having a top segment and a bottom segment including a first end and a second end is provided. The bottom segment includes a curved portion positioned between the first and the second ends, wherein the curved portion is adapted to define an energy storing state and an energy releasing state. The curved portion is adapted to define a first concave configuration corresponding to the energy storing state and a second concave configuration corresponding to the energy releasing state. Further, the first concave configuration corresponds to a first radius of curvature and the second concave configuration corresponds to a second radius of curvature, wherein the first radius of curvature is greater than the second radius of curvature. Further, the first end is joined to the top segment to include an angle there-between; wherein the angle is based on the radius of curvature of the curved portion. Further, the top segment and the bottom segment are made of flexible material.

Thus, the mobility device provides a two flexes—one at the joint of the top and the bottom segment and another one at the curved portion of the bottom segment that provide shock absorption and propulsion. As such, pressure is released from the wrist of the human thereby preventing the wrists from excessive straining and providing better ergonomics. Also, the mobility device can be used by single hand, thereby further reducing the strain from wrists and other parts of body while walking using the mobility device. Additionally, the mobility device may be used together for left and right arms for health and fitness for those with weak/damaged knees or other conditions affecting the lower body.

Further, in context of multi-legged robots having 3 or more legs, the mobility device provides a more energy recovery and saving mechanism while moving. Therefore, the multi-legged robots can propel forward with minimal control. Also, the mobility device is made of flexible material. As such, varying mechanical forces can be applied with minimal mechanical components. Therefore, better ergonomics are provided and better control of mobility is provided for the multi-legged robots.

### BRIEF DESCRIPTION OF DRAWINGS

To further clarify advantages and aspects of the invention, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings, which are listed below for quick reference.

FIGS. 1(a) and 1(b) illustrate a perspective view of a mobility device, in accordance with an embodiment of the present invention.

FIGS. 2-4 illustrate perspective view of a mobility device, in accordance with various embodiments of the present invention.

FIG. 5 illustrates exemplary embodiment while a user uses the mobility device to walk on an inclined plane, in accordance with an embodiment of the present invention.

It may be noted that to the extent possible, like reference numerals have been used to represent like elements in the drawings. Further, those of ordinary skill in the art will appreciate that elements in the drawings are illustrated for simplicity and may not have been necessarily drawn to scale. For example, the dimensions of some of the elements in the drawings may be exaggerated relative to other elements to help to improve understanding of aspects of the invention. Furthermore, the one or more elements may have been represented in the drawings by conventional symbols, and the drawings may show only those specific details that are pertinent to understanding the embodiments of the invention so as not to obscure the drawings with details that will be readily apparent to those of ordinary skill in the art having benefit of the description herein.

### DETAILED DESCRIPTION

It should be understood at the outset that although illustrative implementations of the embodiments of the present disclosure are illustrated below, the present invention may be implemented using any number of techniques, whether currently known or in existence. The present disclosure should in no way be limited to the illustrative implementations, drawings, and techniques illustrated below, including the exemplary design and implementation illustrated and described herein, but may be modified within the scope of the appended claims along with their full scope of equivalents.

Any particular and all details set forth herein are used in the context of some embodiments and therefore should not be necessarily taken as limiting factors to the attached claims. The attached claims and their legal equivalents can be realized in the context of embodiments other than the ones used as illustrative examples in the description below.

Reference will now be made in detail to embodiments of the present disclosure, examples of which are illustrated in the accompanying drawings. Wherever possible, the same reference numbers will be used throughout the drawings to refer to the same or like parts.

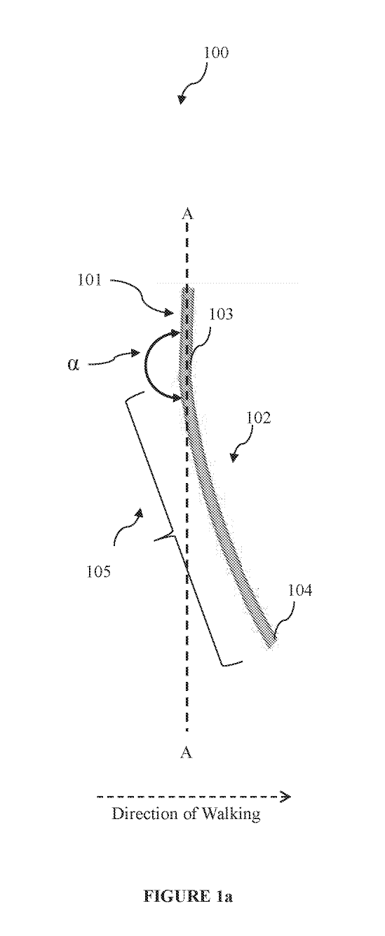

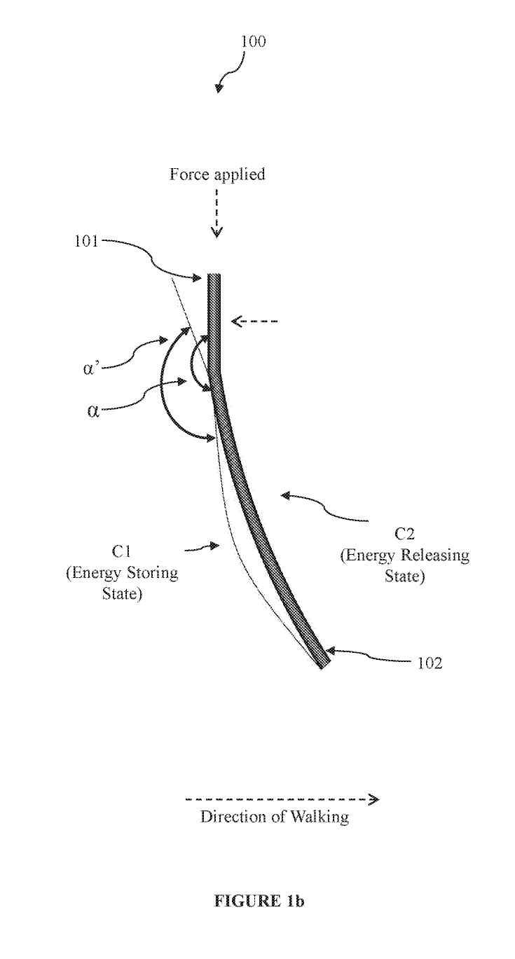

FIG. 1(a) illustrates a perspective view of a mobility device 100, in accordance with an embodiment of the present invention. The mobility device 100 can be implemented as a device providing mobility aid. Examples of the implementation include, but not limited to, walking aid for humans, leg of a multi-legged robot having three or more legs, a crutch, and a hiking equipment.

As illustrated in FIG. 1(a), the mobility device 100 includes top segment 101 and a bottom segment 102. The bottom segment 102 further includes a first end 103 and a second end 104 and the first end 103 is joined to the top segment 101. The bottom segment 102 further includes a curved portion 105 (illustrated using a bracket along the bottom segment 102) positioned between the first end 103 and the second end 104. Further, the curved portion 102 is adapted to define an energy storing state and an energy releasing state, as described in below paragraphs.

Further, the top segment 101 may be a straight portion compared to the curved configuration of the bottom segment 102. In one aspect of the invention, the top segment 101 may be used as a handle enabling a user to hold the mobility device 100. Accordingly, the top segment 101 may include an ergonomic cover so as to enable the user to grip the top segment 101 easily. In another aspect of the invention, the top segment 101 is connected to a multi-legged robot having 3 or more legs. Accordingly, the top segment 101 may be connected with body of the robot such as at upper surface, lower surface, and sidewall surface of the body of the robot. Further, the top segment 101 is mechanically linked with the robot so that a range of vertical and horizontal motions can be adjusted according to a length and height of the robot.

Further, the top segment 101 and the first end 103 of the bottom segment 102 are connected to each other to include a first angle α there-between. The first angle α is based on a radius of curvature of the curved portion 105. Thus, based on the first angle α, the top segment 101 may be parallel or perpendicular or angular (anywhere in between) with respect to a surface. Therefore, in FIG. 1(a), the top segment 101 is perpendicular with respect to the surface. The angle α, at the time of manufacturing, is based upon a desired implementation of the mobility device 100. For example, the first angle α of a walking aid for humans can be lesser than the first angle α for a leg of a multi-legged robot. Additionally, lengths of the top segment 101 and the bottom segment 102 may be varied according to various implementations of the mobility device 100.

Further, the second end 104 of the bottom segment 102 may be provided with an enclosure (not shown in the figure) for engaging with a surface. Example of the enclosure includes a rubber cap and a rubber tip. The enclosure can be level to the surface or at an angle depending upon the desired purpose to prevent the mobility device 100 from slipping. Additionally, the second end 104 is positioned farther from a vertical axis AA of the mobility device 100.

Further, the curved portion 105 of the bottom segment 102 is adapted to define a first concave configuration corresponding to the energy storing state and a second concave configuration corresponding to the energy releasing state. When force is absent on the top segment 102, the curved portion 105 defines a neutral state. When force is exerted on the top segment 102, the bottom segment 102 flexes along the curved portion 105 and accordingly, the curved portion 105 defines a first concave configuration C1 (depicted using solid lines), as illustrated in FIG. 1(b). The degree of flexing is dependent upon various factors including, but without limitation, magnitude of force, material used, and terrain, length/height of the mobility device, position at which the mobility device is held. Further, the first concave configuration corresponds to a first radius of curvature. In addition, as the bottom segment 102 flexes, the first angle α between the top segment 101 and the first end 103 also varies. As such, the variation in the first angle α is dependent of radius of curvature of the bottom segment 102. As illustrated in the FIG. 1(b), when the curved portion 105 defines the first concave configuration C1, angle α′ is defined between the top segment 101 and the first end 103. Thus, the forced exerted on the top segment 101 is stored in the joint between the top segment 101 and the first end 103, and the curved portion 105, and thereby defining the energy storage state.

In an example as illustrated in FIG. 1(b), when the user walks holding the top segment 101 (preferably approx. at his chest height and/or shoulder height), the bottom segment 102 flexes based upon the pressure exerted by the user on the top segment 101. At the same time, the joint between the top segment 101 and the first end 103 flexes based upon the pressure exerted by the user on the top segment 101. This allows pressure to be transferred from the wrists and back during impact with the ground.

When the force is released from the top segment 101, the bottom segment 102 returns to the neutral state along the curved portion 105 and accordingly, the curved portion 105 defines the second concave configuration C2 as illustrated in FIG. 1(b). Further, the second concave configuration C2 corresponds to a second radius of curvature, wherein the first radius of curvature is greater than the second radius of curvature. It would be understood that the second concave configuration C2 of the curved portion 105 is same as that of prior to exertion of force on the top segment 101. As described above, the first angle α is dependent of radius of curvature of the bottom segment 102. Therefore, when the second concave configuration C2 is attained, the angle between the top segment 101 and the first end 103 changes from α′ to α.

Thus, the force stored in the curved portion 105 and the joint between the top segment 101 and the first end 103 is released defining the energy released state. The energy is released within a minimum time, which is lesser than a time taken to reach the energy storage state. And therefore a propulsion force is experienced. In the above example, when the user releases the pressure from the top segment 101, the stored energy is released providing forward propulsion to the user.

Thus, the mobility device 100 provides a two flexes—one at the joint of the top segment 101 and the first end 103 of the bottom segment 102 and another one at the curved portion 105 of the bottom segment 102. This enables better transfer and storage of energy and results in better shock absorption. Additionally, a lot of strain is removed from the wrists and other parts of the body. Further, as the energy is released, propulsion is provided, thereby enabling the user to move forward with minimal efforts.

Further, the top segment 101 and the bottom segment 102 are integrally formed in a single part. In one aspect of the invention, the top segment 101 is joined with the first end 103 of the bottom segment 102 using a coupling which enables flexing. Example of such coupling includes ball and socket joint.

Further, a length of the mobility device 100 can be varied in accordance with desired implementation of the mobility device 100. For instance, if the user wishes to use the mobility device 100 as a crutch, the length of the mobility device 100 may be shoulder length while if the mobility device 100 is to be used for uphill climbing, the length of mobility device 100 may be waist-length or slightly more than the waist-length to about chest and/or shoulder height. In one aspect of the invention, only length of the bottom segment 102 may be varied in accordance with desired implementation of the mobility device 100 while keeping a length of the top segment 101 fixed. In another aspect of the invention, length of the bottom segment 102 and the top segment 101 may be varied in accordance with desired implementation of the mobility device 100.

Further, the top segment 101 and the bottom segment 102 can be manufactured with a flexible material of required resiliency and maximum tensile strengths. Examples of the flexible material include, but not limited to, composites of fiberglass, composites of Kevlar, composites of graphite, spring, coiled structure, and combinations thereof. In one aspect of the invention, both the top segment 101 and the bottom segment 102 are manufactured with common flexible material. In another aspect of the invention, the top segment 101 and the bottom segment 102 are manufactured with different flexible materials.

Further, the curved portion 105 of the bottom segment 102 can be manufactured in various forms in accordance with desired implementation of the mobility device 100. In one aspect of the invention, the curved portion 105 is designed as a combination of plurality of smaller curvature curved portions. In another aspect of the invention, the curved portion 105 is designed as a combination of plurality of smaller straight portions such that a single curved portion is formed.

Further, thickness of the top segment 101 and the bottom segment 102 may be varied along an entire length of the mobility device 100 such that it caters to desired stiffness, tensile strength and range of elasticity of the mobility device 100. For example, the bottom segment 102 may taper at the second end 104. In one aspect of the invention, a size and shape of cross-section may determine the thickness of the top segment 101 and the bottom segment 102. For example, if the cross-section is rectangular/oblong, the thickness of the top segment 101 and the bottom segment 102 may vary depending on a direction in which the bottom segment 102 is flexed. It is to be understood that the flexible material, the length, and cross-sectional shape and size of the top segment 101 and the bottom segment 102 may determine the stiffness, flexibility, and elasticity of the mobility device 100. Further, in another aspect of the invention, the top segment 101 and the bottom segment 102 may be hollow and still cater to desired stiffness, tensile strength and range of elasticity of the mobility device 100.

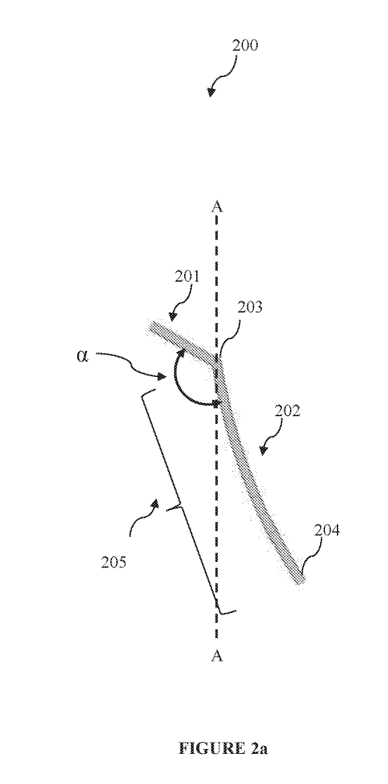

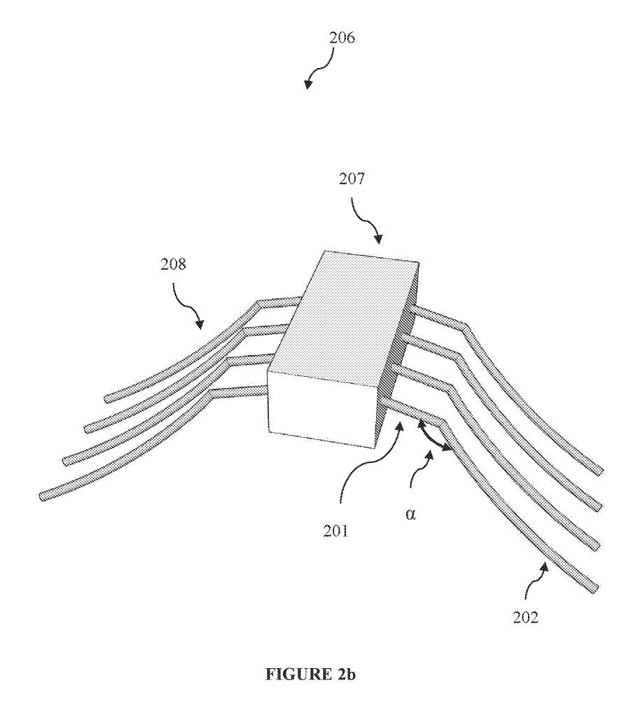

FIG. 2(a) illustrates a perspective view of the mobility device 200 in accordance with another embodiment of the invention. Similar to FIG. 1, the mobility device 200 includes a top segment 201 and bottom segment 202. Further, the bottom segment includes a first end 203, a second 204, and a curved portion 205. Additionally, the second end 204 is positioned farther from a vertical axis AA of the mobility device 200. As described above, based on the angle α, top segment of the mobility device 200 may be parallel or perpendicular or angular with respect to a surface. Thus, in FIG. 2, the top segment 201 is angular with respect to the surface. Accordingly, the grip would change from a downward facing direction to a forward facing grip. In an example, such mobility device 200 is used for trekking purposes. In such example, a length of mobility device 200 may be about chest and/or shoulder height.

Further, in another example, the mobility device 200 can be attached with a body of a multi-legged robot. Examples of the multi-legged robot include, but not limited, unmanned ground vehicle (UGV) and unmanned aerial vehicle (UAV). FIG. 2b illustrates an isometric view of an example multi-legged robot 206 having a body 207 and a plurality of legs 208 joined to the body 207. In accordance with the invention, the plurality of legs 208 are implemented using the mobility device 200. In one aspect of the invention, a plurality of mobile devices 200 can be coupled with the robot such that combinations of outward and inward facing curves are provided for balanced dynamics. In one example, back legs of the robot could have inward facing curves and front legs of the robot could have outward facing curve. Thus, the mobility device 200 is advantageous for both landing and take-off due to absorption and potential ‘jumping’ or propulsion capabilities.

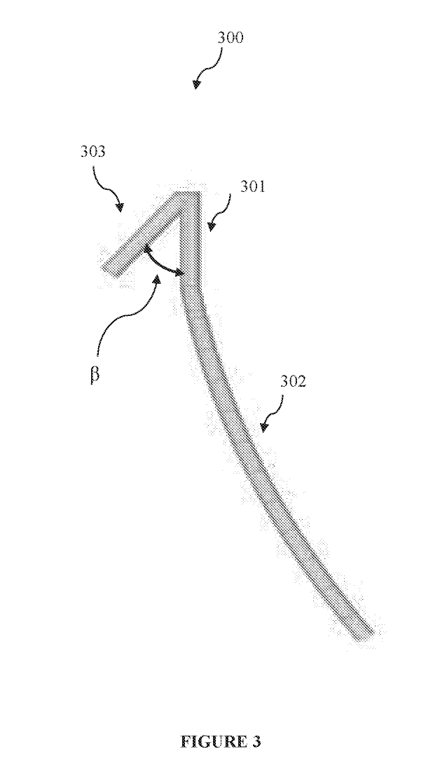

FIG. 3 illustrates a perspective view of the mobility device 300 in accordance with one another embodiment of the invention. Similar to FIG. 1, the mobility device 300 includes a top segment 301 and bottom segment 302. Further, the mobility device 300 includes an additional segment 303 attached at second angle β to the top segment 301. The second angle β, at the time of manufacturing, is based upon a desired implementation of the mobility device 100. Additionally, similar to first angle α, the second angle β varies upon application of force, as illustrated in FIG. 1(b). As such, the variation in the second angle β is dependent of radius of curvature of the bottom segment 302. Thus, the additional segment 303 provides additional support and greater mobility.

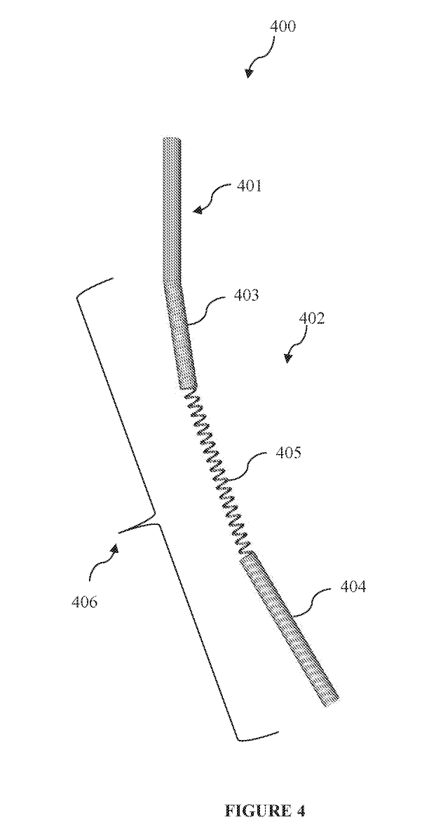

FIG. 4 illustrates a perspective view of the mobility device 300 in accordance with yet another embodiment of the invention. Similar to FIG. 1, the mobility device 400 includes a top segment 401 and bottom segment 402. Further, flexing of the bottom segment 402 may be achieved by attaching a spring/coiled structure to the bottom segment 402 of the mobility device 400. The bottom segment 102 may be a three part structure with a first bar 403, a second bar 404, and a spring or coiled structure 405 there between. The first bar 403 and the second bar 404 are made of rigid material. On application of force, the bottom segment 402 may flex such that the spring or coiled structure 405 may compress and/or the first bar 403 and the second bar 404 may curve at joints with the spring or coiled structure 405 to bear the force exerted on the top segment 401. Thus, a curved portion 406 (illustrated using a bracket) of the bottom segment 402 is made of spring or coiled structure 405, the first bar 403, and the second bar 404. This flexing relieves the strain in the arms of a user while keeping the back upright.

Further, in one aspect of the invention, the mobility device as described with reference to FIG. 1-2, may act as smart device and may be configured to be compatible with a smart phone or any other smart electronic device. The mobility device may be provided with an LED display and may be embedded with additional sensors such as magnetic compass, pressure sensors, touch sensors etc. The mobility device may be Bluetooth, Wi-Fi compatible and may contain an USB port and additional input/output ports. An electronic circuitry and a smart chip may be embedded in the mobility device for providing and controlling the functionality of the aforesaid components.

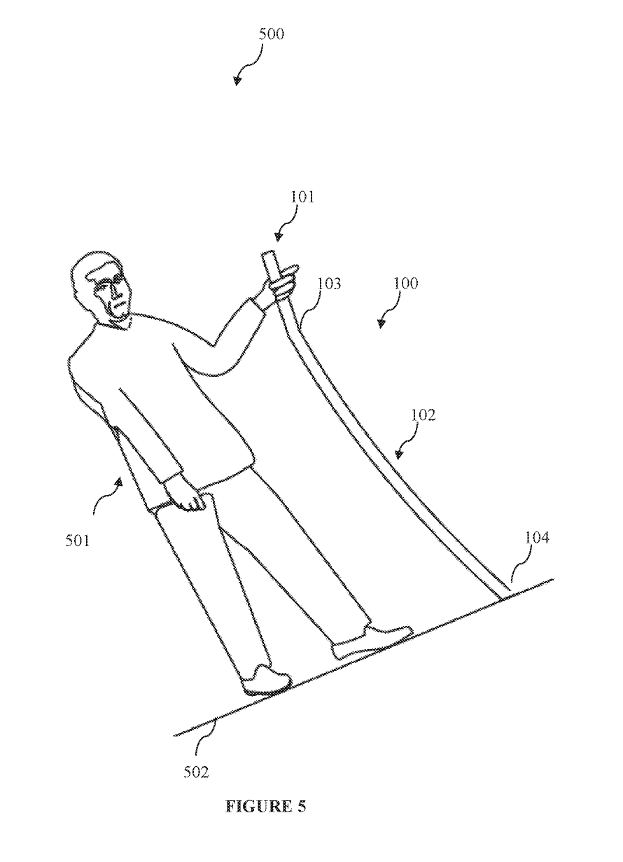

FIG. 5 illustrates exemplary implementation 500 of the mobility device 100 as a walking aid while a user 501 uses the mobility device 101 to walk on an inclined surface 502. It would be understood that though the explanation is provided using the mobility device 100 of FIG. 1(a), embodiments shown in other figures work in the same manner.

As depicted in FIG. 5, for the sake of brevity and ease of reference, the inclined surface 502 is a plane surface. As such, the mobility device 100 remains in its original configuration, i.e., the curved portion 105 faces inwards from the direction of the user 501, and the bottom segment 102 of the mobility device 100 is positioned farther from a feet of the user 501 while the top segment 101 is held by the user 501. In addition, a length of the mobility device 100 is approximately equal to a shoulder length of the user 501. As the user 501 climbs uphill on the inclined plane 502, the second end 104 of the bottom segment 102 is placed at an elevation as opposed to the feet of the user 501. As the user 501 takes a step forward after placing the mobility device 100 forward on the inclined plane 502, the user 501 exerts a force on the mobility device 100. As would be understood, this force is a result of the transfer of the user's weight to the mobility device 100. Accordingly, the bottom segment 102 flexes along the curved portion 105 and the angle α varies in accordance with radius of curvature of the curved portion 105 such that the joint between the top segment 101 and the first end 103 flexes. As such, the energy is stored in the bottom segment 102 and the joint between the top segment 101 and the first end 103. Once the user 501 has taken a step upwards, the stored energy in the mobility device 100 is released allowing the bottom segment 102 to attain the original shape and propelling the user 501 forward.

Similarly, as the user 501 descents downhill on the inclined plane 502, the user 501 can reverse the mobility device 100 such that the curved portion 105 faces outwards from the direction of the user 501.

Further, in one aspect of the invention, the user 501 can reverse the mobility device 100 such that the curved portion 105 faces outwards from the direction of the user 501. In such a scenario, the mobility device 100 returns to original configuration, i.e., the curved portion 105 faces inwards from the direction of the user 501 due to centre of gravity when the mobility device 100 is held loosely on the inclined plane, provided the mobility device 100 has enough mass. This phenomenon is generally termed as self-righting.

While certain present preferred embodiments of the invention have been illustrated and described herein, it is to be understood that the invention is not limited thereto. Clearly, the invention may be otherwise variously embodied, and practiced within the scope of the following claims.

We claim:

1. A mobility device comprising:
top segment; and a
bottom segment including a first end and a second end, the first end being joined to the top segment, said bottom segment including a curved portion positioned between the first and the second ends, wherein the curved portion is adapted to define an energy storing state and an energy releasing state.

2. The mobility device as claimed in claim 1, wherein the curved portion is further adapted to define a first concave configuration corresponding to the energy storing state and a second concave configuration corresponding to the energy releasing state.

3. The mobility device as claimed in claim 2, wherein the first concave configuration corresponds to a first radius of curvature and the second concave configuration corresponds to a second radius of curvature, and wherein the first radius of curvature is greater than the second radius of curvature.

4. The mobility device as claimed in claim 1, wherein the first end of the bottom segment and the top segment are connected to each other to include a first angle there-between.

5. The mobility device as claimed in claim 4, wherein the angle is based on a radius of curvature of the curved portion such that the first angle corresponds to one of the energy storing state and the energy releasing state.

6. The mobility device as claimed in claim 1, wherein the second end of the bottom segment is positioned farther from a vertical axis of the top segment.

7. The mobility device as claimed in claim 1, wherein the bottom segment is made from one of: a flexible material, a spring, and combination thereof.

8. The mobility device as claimed in claim 1, wherein the top segment is made of a flexible material.

9. The mobility device as claimed in claim 1, wherein the top segment and the bottom segment are integrally formed in a single part.

10. The mobility device as claimed in claim 1, wherein the mobility device is walking aid.

11. The mobility device as claimed in claim 1, wherein the mobility device is robot leg.

12. The mobility device as claimed in claim 1, wherein the mobility device is embedded with an electronic circuitry and sensors.

13. The mobility device as claimed in claim 11, wherein the mobility device further includes an additional segment such that the additional segment and the top segment are joined to include a second angle there-between.

14. The mobility device as claimed in claim 13, wherein the angle is based on a radius of curvature of the curved portion such that the second angle corresponds to one of the energy storing state and the energy releasing state.
